(19) United States
(12) Patent Application Publication
(10) Pub. No.: US 2023/0005180 A1
(43) Pub. Date: Jan. 5, 2023

(54) EYE TRACKING SYSTEM

(71) Applicant: TOBII AB, Danderyd (SE)

(72) Inventors: Joakim ZACHRISSON, Danderyd (SE); Mikael ROSELL, Danderyd (SE); Ylva BJORK, Danderyd (SE); Simon JOHANSSON, Danderyd (SE)

(21) Appl. No.: 17/810,027

(22) Filed: Jun. 30, 2022

(30) Foreign Application Priority Data
Jun. 30, 2021 (SE) 2150850-2

(51) Int. Cl. G06T 7/73; G06T 7/00; G06V 40/18

(52) U.S. Cl. CPC G06T 7/74; G06T 7/0002; G06V 40/193; G06V 40/197; G06T 2207/30201; G06T 2207/30168

(57) ABSTRACT

An eye tracking system provides a quality measure of a calculated gaze of a user. The eye tracking system receives gaze data including left eye gaze data associated with a left eye of the user and right eye gaze data associated with a right eye of the user. The eye tracking system compares the left eye gaze data and the right eye gaze data to determine a gaze difference value. The eye tracking system provides a gaze quality value of the gaze data based on the gaze difference value.

### CROSS-REFERENCES TO RELATED APPLICATIONS

This application claims priority to Swedish Application No. 2150850-2, entitled “AN EYE TRACKING SYSTEM,” filed on Jun. 30, 2021. The entire disclosure of the above-referenced application is incorporated herein by this reference.

### FIELD

The present disclosure generally relates to the field of eye tracking. In particular, the present disclosure relates to eye tracking systems and methods for providing a gaze quality value for assessing eye tracking quality.

### BACKGROUND

In eye tracking applications, digital images are retrieved of the eyes of a user and the digital images are analyzed in order to estimate the gaze direction of the user. The estimation of the gaze direction may be based on computer-based image analysis of features of the imaged eye. One known example method of eye tracking includes the use of infrared light and an image sensor. The infrared light is directed towards the pupil of a user and the reflection of the light is captured by an image sensor.

Many eye tracking systems estimate gaze direction based on identification of a pupil position together with glints or corneal reflections. Therefore, accuracy in the estimation of gaze direction may depend upon an accuracy of the identification or detection of the pupil position and/or the corneal reflections. One or more spurious image features such as stray reflections may be present in the digital images which can detrimentally affect eye feature identification. For example, spurious image features can result in incorrect glint to illuminator matching and/or an incorrect pupil position, resulting in an erroneous gaze determination. It can be difficult to determine when such errors have occurred and eye tracking systems can get stuck in an erroneous tracking sequence.

Portable or wearable eye tracking devices have also been previously described. One such eye tracking system is described in U.S. Pat. No. 9,041,787 (which is hereby incorporated by reference in its entirety). A wearable eye tracking device is described using illuminators and image sensors for determining gaze direction.

### SUMMARY

According to a first aspect of the present disclosure there is provided an eye tracking system for providing a quality measure of a calculated gaze of a user, the eye tracking system comprising a controller configured to: receive left eye gaze data associated with a left eye of the user; receive right eye gaze data associated with a right eye of the user; compare the left eye gaze data and the right eye gaze data to determine a gaze difference value; and provide a gaze quality value of the gaze data based on the gaze difference value.

The gaze quality value can advantageously be used to provide feedback to the pupil detection and corneal estimation processes to reduce processing requirements for subsequent images. This can be useful because the difference in these intermediate parameters (pupil position, pupil radius, cornea position etc.) from one image frame to the next may be small. If an intermediate parameter is known to be accurate for a frame, approximations can be made that can reduce the computational requirements for subsequent image processing.

The controller may be configured to provide: the gaze quality value as TRUE if the gaze difference value is within the threshold range; and the gaze quality value as FALSE if the gaze difference value is outside the threshold range.

The left eye gaze data and the right eye gaze data may comprise gaze direction data. The left eye gaze data and the right eye data may comprise gaze point data corresponding to an intersection of a respective left eye gaze ray and right eye gaze ray with a plane or surface. The left eye gaze data and the right eye gaze data may comprise gaze origin data. The left eye gaze data and the right eye gaze data correspond to the same frame of reference. The controller may be configured to provide the gaze quality value based on whether or not the gaze difference value is within a gaze origin threshold range. A horizontal component of the gaze origin threshold range may be centered around an eye separation offset value. The left eye gaze data and the right eye gaze data may correspond to a single image frame for each eye.

The left eye gaze data and the right eye gaze data correspond to a plurality of image frames for each eye. The controller may be configured to: determine a gaze difference value for each image frame; and determine the gaze quality value based on whether or not all the gaze difference values are within a threshold range. The controller may be configured to compare the left eye gaze data and the right eye gaze data to a feasibility threshold range and provide the gaze quality value as FALSE if the left eye gaze data and/or the right eye gaze data is outside the feasibility threshold range. The eye tracking system may be configured to output the gaze data to a subsequent application based on the gaze quality value.

The eye tracking system may further comprise one or more intermediate modules configured to determine an intermediate value for determining the gaze data. The controller may be configured to provide the gaze quality value to the one or more intermediate modules such that the intermediate modules can calculate the intermediate value based on the gaze quality value. The one or more intermediate modules may be configured to: reset if the gaze quality value is FALSE; and use the intermediate value as a starting point for determining the intermediate value for a subsequent image frame if the gaze quality value is TRUE. The one or more intermediate modules may comprise any of a pupil detection module, a glint matching module, a corneal center estimation module and a gaze estimation module.

The eye tracking system may be configured to store the right eye gaze data and the left eye gaze data as key frame data if the gaze quality value is TRUE. If the gaze quality value is TRUE and one of the left eye gaze data and the right eye gaze data comprises no value for a subsequent image frame and the other one of the left eye gaze data and right eye gaze data comprises a definite value for the subsequent image frame, the controller may be configured to compare the definite value to the key frame data to determine the gaze difference value. If the gaze quality value is TRUE and the left eye gaze data and the right eye gaze data comprise no value for up to a predetermined number of subsequent image frames, the controller may be configured to provide a TRUE gaze quality value. If the gaze quality value is TRUE the gaze difference value is outside the threshold range for up to a predetermined number of subsequent image frames, the controller may be configured to provide a TRUE gaze quality value.

According to a second aspect of the present disclosure there is provided a head-mounted device comprising any of the eye tracking systems disclosed herein. According to a third aspect of the present disclosure, there is provided a method of providing a quality measure of a calculated gaze of a user, the method comprising: receiving left eye gaze data associated with a left eye of the user; receiving right eye gaze data associated with a right eye of the user; comparing the left eye gaze data and the right eye gaze data to determine a gaze difference value; and providing a gaze quality value of the gaze data based on the gaze difference value. According to a fourth aspect of the present disclosure there is provided one or more non-transitory computer-readable storage media storing computer-executable instructions that, when executed by a computing system, causes the computing system to perform any method disclosed herein.

### BRIEF DESCRIPTION OF THE DRAWINGS

One or more embodiments will now be described by way of example only with reference to the accompanying drawings in which:

FIG. 1 shows a schematic view of an eye tracking system which may be used to capture a sequence of images that can be used by example embodiments;

FIG. 2 shows an example image of a pair of eyes;

FIG. 3 shows an example of an eye tracking system according to an embodiment of the present disclosure; and

FIG. 4 illustrates schematically a method according to an embodiment of the present disclosure.

### DETAILED DESCRIPTION

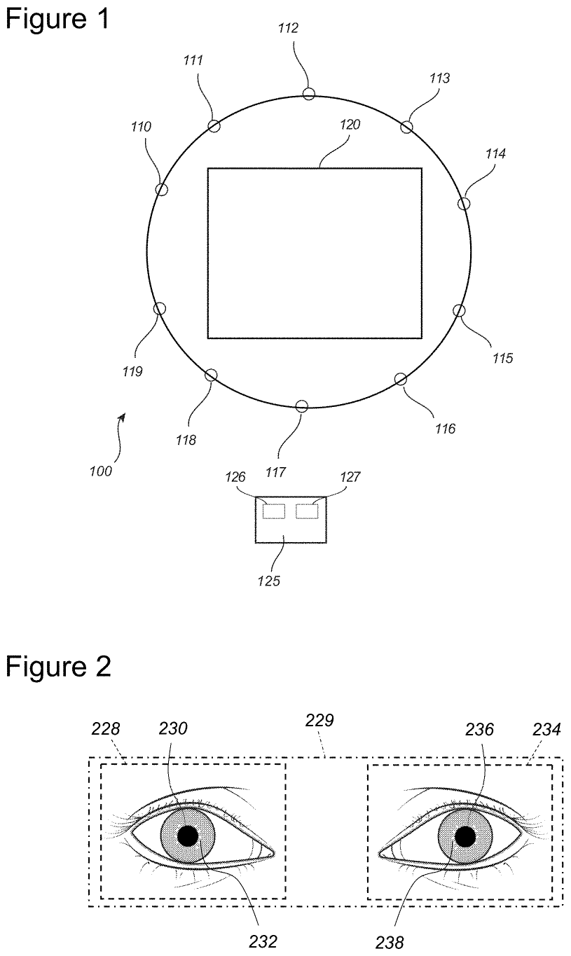

FIG. 1 shows a simplified view of an eye tracking system 100 (which may also be referred to as a gaze tracking system) in a head-mounted device in the form of a virtual or augmented reality (VR or AR) device or VR or AR glasses or anything related, such as extended reality (XR) or mixed reality (MR) headsets. The system 100 comprises an image sensor 120 (e.g. a camera) for capturing images of the eyes of the user. The system may optionally include one or more illuminators 110-119 for illuminating the eyes of a user, which may for example be light emitting diodes emitting light in the infrared frequency band, or in the near infrared frequency band and which may be physically arranged in a variety of configurations. The image sensor 120 may for example be an image sensor of any type, such as a complementary metal oxide semiconductor (CMOS) image sensor or a charged coupled device (CCD) image sensor. The image sensor may consist of an integrated circuit containing an array of pixel sensors, each pixel containing a photodetector and an active amplifier. The image sensor may be capable of converting light into digital signals. In one or more examples, it could be an Infrared image sensor or IR image sensor, an RGB sensor, an RGBW sensor or an RGB or RGBW sensor with IR filter.

The eye tracking system 100 may comprise circuitry or one or more controllers 125, for example including a receiver 126 and processing circuitry 127, for receiving and processing the images captured by the image sensor 120. The circuitry 125 may for example be connected to the image sensor 120 and the optional one or more illuminators 110-119 via a wired or a wireless connection and be co-located with the image sensor 120 and the one or more illuminators 110-119 or located at a distance, e.g. in a different device. In another example, the circuitry 125 may be provided in one or more stacked layers below the light sensitive surface of the light sensor 120.

The eye tracking system 100 may include a display (not shown) for presenting information and/or visual stimuli to the user. The display may comprise a VR display which presents imagery and substantially blocks the user's view of the real-world or an AR display which presents imagery that is to be perceived as overlaid over the user's view of the real-world.

The location of the image sensor 120 for one eye in such a system 100 is generally away from the line of sight for the user in order not to obscure the display for that eye. This configuration may be, for example, enabled by means of so-called hot mirrors which reflect a portion of the light and allows the rest of the light to pass, e.g. infrared light is reflected, and visible light is allowed to pass.

While in the above example the images of the user's eye are captured by a head-mounted image sensor 120, in other examples the images may be captured by an image sensor that is not head-mounted. Such a non-head-mounted system may be referred to as a remote system.

In an eye tracking system, a gaze signal can be computed per each eye of the user (left and right). The quality of these gaze signals can be reduced by disturbances in the input images (such as image noise) and by incorrect algorithm behavior (such as incorrect predictions). A goal of the eye tracking system is to deliver a gaze signal that is as good as possible, both in terms of accuracy (bias error) and precision (variance error). For many applications it can be sufficient to deliver only one gaze signal per time instance, rather than both the gaze of the left and right eyes individually. Further, the combined gaze signal can be provided in combination with the left and right signals. Such a gaze signal can be referred to as a combined gaze signal.

FIG. 2 shows a simplified example of an image 229 of a pair of eyes, captured by an eye tracking system such as the system of FIG. 1. The image 229 can be considered as including a right-eye-image 228, of a person's right eye, and a left-eye-image 234, of the person's left eye. In this example the right-eye-image 228 and the left-eye-image 234 are both parts of a larger image of both of the person's eyes. In other examples, separate image sensors may be used to acquire the right-eye-image 228 and the left-eye-image 234.

The system may employ image processing (such as digital image processing) for extracting features in the image. The system may for example identify the location of the pupil 230, 236 in the one or more images captured by the image sensor. The system may determine the location of the pupil 230, 236 using a pupil detection process. The system may also identify corneal reflections 232, 238 located in close proximity to the pupil 230, 236. The system may estimate a corneal center or eye ball center based on the corneal reflections 232, 238. For example, the system may match each of the individual corneal reflections 232, 238 for each eye with a corresponding illuminator and determine the corneal center of each eye based on the matching. The system can then determine a gaze ray (which may also be referred to as a gaze vector) for each eye including a position vector and a direction vector. The gaze ray may be based on a gaze origin and gaze direction which can be determined from the respective glint to illuminator matching/corneal centers and the determined pupil position. The gaze direction and gaze origin may themselves be separate vectors. The gaze rays for each eye may be combined to provide a combined gaze ray.

As mentioned above, any errors in glint to illuminator matching (which may simply be referred to as glint matching) or pupil position determination can result in an incorrect gaze determination. The results of glint matching and pupil detection can be considered as binary. For glint matching, either the glint matching is correct and a cornea position is determined that is good enough for accurate gaze computation, or it is incorrect which results in a cornea position that cannot be used to accurately map gaze. Similarly, for pupil detection, either the detected pupil is close enough for circle fitting to accurately identify a pupil, or it is incorrect such that the correct pupil cannot be identified and cannot be used to accurately map gaze. However, errors in determining these intermediate parameters can be difficult to detect. As a result, some systems can get stuck in an incorrect tracking regime and provide an insufficient gaze determination. This can be particularly detrimental for many eye tracking applications. One such application is foveated rendering in which an image quality is reduced in the user's peripheral vision as determined by their calculated gaze.

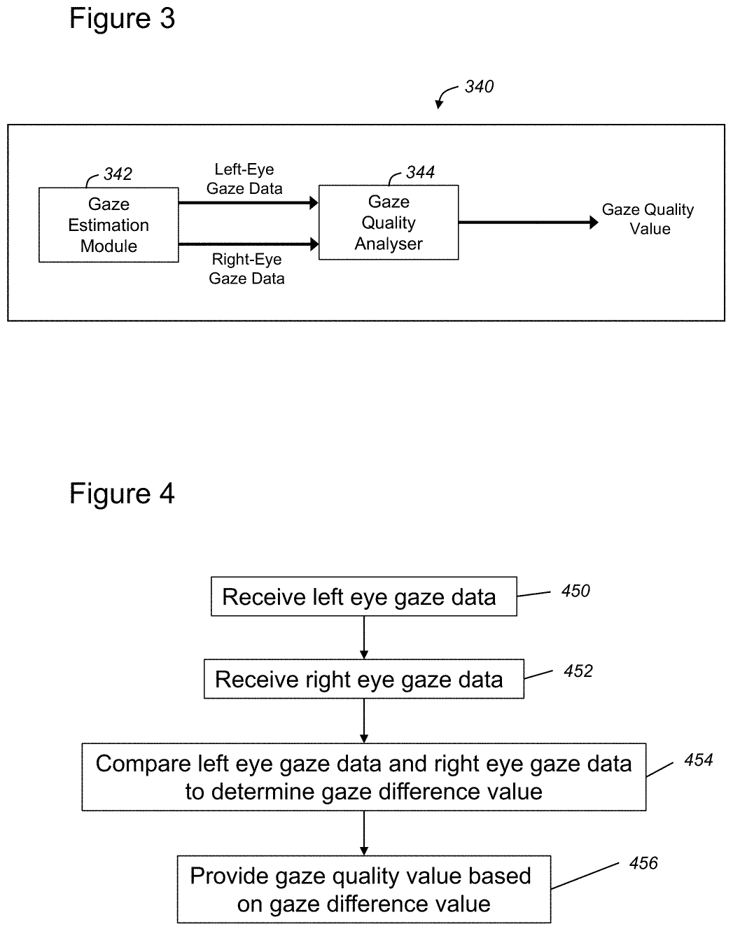

FIG. 3 shows an example of an eye tracking system 340 according to an embodiment of the present disclosure. The functionality that is illustrated in FIG. 3 may be provided by one or more controllers. The eye tracking system may be part of, or associated with, a head-mounted device or a remote system. The eye tracking system 340 provides a gaze quality value that is representative of a reliability or accuracy of a gaze calculation for a user. The gaze quality value can advantageously be used to provide feedback to the pupil detection and corneal estimation processes to reduce processing requirements for subsequent images. This can be useful because the difference in these intermediate parameters (pupil position, pupil radius, cornea position etc.) from one image frame to the next may be small. If an intermediate parameter is known to be accurate for a frame, approximations can be made that can reduce the computational requirements for subsequent image processing. For example, the searchable area of an image may be reduced to an area surrounding the accurate pupil position for the present frame. In addition, or alternatively, the eye tracking system may output a user gaze signal for a subsequent application (such as an end application) based on the gaze quality value, as will be discussed in more detail below. It will be appreciated that the various modules of the eye tracking system 340 that are described below may be embodied in software or hardware.

The eye tracking system 340 comprises a controller 344, which in this example is described as a gaze quality analyzer 344. The gaze quality analyzer 344 receives left eye gaze data, associated with a left eye of the user, from a gaze estimation module 342. The gaze quality analyzer 344 also receives right eye data, associated with a right eye of the user, from the gaze estimation module 344. The gaze quality analyzer 344 compares the left eye gaze data and the right eye gaze data to determine a gaze difference value. The gaze quality analyzer 344 further provides a gaze quality value based on the gaze difference value. In this example, the eye tracking system 340 comprises the gaze estimation module 342 but in other examples the gaze estimation module 342 may form part of a separate or linked system.

The gaze quality value may provide an indication of the reliability of the gaze data for both eyes. A higher value of the gaze quality value may be associated with more reliable gaze data. A higher value of the gaze quality value can therefore be used as an indicator or assessment of eye tracking quality. In some examples, the gaze quality value may be binary and take either a TRUE (logic 1) or FALSE (logic 0) value. A TRUE value may indicate that the gaze data is sufficiently accurate for gaze tracking and a FALSE value may indicate that the gaze data is not sufficiently accurate for gaze tracking. To provide a binary gaze quality value, the gaze quality analyzer 344 may provide the gaze quality value based on whether or not the gaze difference value is within a threshold range. If the gaze difference value is within the threshold range, the gaze quality analyzer 344 may provide a TRUE value of the gaze quality value, and vice versa. In this way, the gaze quality analyzer 344 can provide a binary quality measurement of the gaze data or gaze signal.

The gaze quality analyzer 344 may provide the gaze quality value as an output signal. The eye tracking system may provide the gaze data to, or use the gaze data in, a subsequent application (such as an end application) based on the gaze quality value in the output signal. For example, if the gaze quality value is TRUE, the eye tracking system 340 may provide the gaze data to the subsequent application. If the gaze quality value is FALSE, the eye tracking system 340 may provide a null value to the subsequent application or return a previous value of the gaze data when the gaze quality value was TRUE.

As outlined above, the calculated gaze data (such as gaze ray, gaze direction and gaze origin) may be dependent on one or more determined intermediate parameters, for example pupil position, glint matches or corneal center. If the gaze quality value is TRUE indicating no error (or minimal error) in the gaze data, the corresponding intermediate parameters will also be error free (or have minimal error). Therefore, the gaze quality analyzer 344 may provide the gaze quality value to one or more intermediate modules of the eye tracking system 340 that determine these intermediate parameters such that the intermediate modules can recalculate the intermediate parameter values based on the gaze quality value. For example, the gaze quality analyzer 344 may provide the gaze quality value to the gaze estimation module 342, a pupil detection module, a glint matching module, a corneal center estimation module and/or similar modules. If the gaze quality value is TRUE, the one or more intermediate module can lock a value of the corresponding intermediate parameter or use the value of the intermediate parameter as basis for a subsequent determination. For example, a glint matching module may lock the matching of glints to illuminators until a significant change is detected in an image frame. Similarly, a pupil position module may limit an area of an image frame to within a certain radius of a value of the pupil position when scanning a subsequent image to determine pupil position. Conversely, if the gaze quality value is FALSE, the one or more intermediate modules may reset and determine the corresponding intermediate parameter from first principles with no a-priori knowledge of a trusted value. For example, the pupil position module may scan an entire image when searching for candidate pupil positions. By providing the gaze quality value to the one or more intermediate modules, the eye tracking system can advantageously reduce computational requirements when the gaze quality value is high and may lock or track particular intermediate values or the gaze data itself. Providing the gaze quality value to the one or more intermediate modules can also reduce a risk that the intermediate module selects an incorrect solution when testing different hypotheses — that is, when selecting a solution from a plurality of candidate solutions.

The gaze data for each eye may comprise gaze direction data. The gaze direction data may comprise the gaze direction (directional component) of the gaze ray. For example, the gaze direction data may comprise a normalized direction vector in 3D space or may comprise an angle or rotation of the gaze ray with respect to one or more axes. The gaze direction or angle may be measured with respect to a reference-vector or zero-vector. The reference vector may correspond to a vector perpendicular to a plane of the respective image of the eye. The gaze direction data may also be represented by a quaternion.

The gaze estimation module may determine the gaze direction data based on a pupil position and/or a corneal center or gaze origin determined by the eye tracking system. Algorithms for determining gaze direction based on a pupil position and/or a corneal center are known in the art and will not be described here.

When each eye is focused at infinity, the gaze direction for each eye of a user should be parallel. When each eye is focused on an object in the near field, the gaze directions for each eye are likely to have a natural offset of a few degrees. If the gaze estimation module 344 provides gaze direction data for one or both eyes comprising a calculation error (for example due to incorrect glint matching or an incorrectly estimated pupil position) the offset in gaze direction between the left eye and right eye is likely to be much larger than the near field natural offset. Therefore, if the difference in angle between left and right gaze directions is small it can be assumed that the gaze is correct, the glint matching is correct and the pupils are correctly located. To realize this, the gaze quality analyzer 344 can determine the gaze difference value as a gaze direction difference between left eye gaze direction data and right eye gaze direction data. The gaze direction difference may be determined based on a relative measure of the left eye gaze direction data to the right eye gaze direction data. For example, the gaze direction difference may be an absolute value of the vectorial difference between left eye gaze direction and a right eye gaze direction. Alternatively, the gaze direction difference may comprise an angle between the left eye gaze direction and the right eye gaze direction. The angle may be determined based on the inverse cosine of the scalar product of the left eye gaze direction and the right eye gaze direction. The gaze direction difference may be calculated in other ways such as using a ratio or other relative measure. The gaze quality analyzer 344 can determine the gaze quality value based on the gaze direction difference. The gaze estimation module 342 may determine the left eye gaze data independently from the right eye gaze data. As a result, the probability that the determination of the left eye gaze direction data and the determination of the right eye gaze direction both comprise errors that result in the same overall gaze direction error for each eye is sufficiently low to provide an accurate gaze quality value and robust eye tracking performance. In other words, the likelihood of both corneas and/or both pupils being incorrect while mapping gaze that is consistent between both eyes is negligible.

In some examples, the gaze quality analyzer 344 may compare the gaze direction difference value to one or more gaze direction thresholds. The one or more gaze direction thresholds may define a threshold range. The threshold range may be centered around a gaze direction difference value of zero, such that a first threshold corresponds to a positive gaze direction difference value and a second threshold corresponds to a negative gaze direction difference value. If the gaze direction difference value falls outside the threshold range, the gaze quality analyzer 344 may provide a FALSE gaze quality value. If the gaze direction difference value is within the threshold range, the gaze quality analyzer 344 may provide a TRUE gaze quality value.

The one or more gaze direction thresholds may correspond to different directional components or axes. For example, a first threshold may relate to a horizontal component of the gaze direction difference value and a second threshold may relate to a vertical component of the gaze direction difference value. In some examples, the gaze quality analyzer 344 may compare a magnitude of the gaze direction difference value to a single gaze direction threshold. In such examples, the threshold range may comprise a range of the magnitude of the gaze difference value from zero to a threshold T.

The left eye and right eye gaze data may comprise gaze point data corresponding to a representation of the respective left eye gaze ray/right eye gaze ray as a point on a surface, for example a screen or a display. The gaze difference value may comprise a distance between a left eye gaze point and a right eye gaze point corresponding to the intersection of the respective gaze ray with the surface. The gaze quality analyzer 344 may determine a gaze quality value from the gaze difference value in an analogous way to that described above for gaze direction, for example, by comparing the gaze difference value to a threshold range.

The left eye and right eye gaze data may comprise gaze origin data comprising a respective gaze origin. The gaze origin may comprise a positional component of the gaze vector. The gaze origin may correspond to a corneal center or eyeball center and may be determined based on matching glints to illuminators. Algorithms for matching glints and determining corneal center/gaze origin are known in the art and will not be described here.

In a similar way to gaze direction, the gaze origin for the left eye and the gaze origin for the right eye, with respect to a respective frame of reference for each eye, will remain substantially the same for a user as they move their eyes. In contrast, an error in determination of the gaze origin data for one or both eyes will result in a relatively large deviation between the respective gaze origins. As a result, the gaze quality analyzer 344 can determine a gaze origin difference value based on a difference between a left eye gaze origin with a right eye gaze origin. The gaze quality analyzer 344 may determine the gaze quality value based on the gaze origin difference value.

In some examples, the gaze quality analyzer 344 may compare the gaze origin difference value to one or more gaze origin thresholds. The one or more gaze origin thresholds may define a threshold range.

If the gaze estimation module provides the left eye gaze origin data and the right eye gaze origin data with respect to individual frames of reference for each eye (for example each eye is imaged with an individual sensor), the threshold range may be centered around a gaze origin difference value of zero, such that a first threshold corresponds to a positive gaze origin difference value and a second threshold corresponds to a negative gaze origin difference value. In some examples, the threshold range may be centered around an origin offset value corresponding to an offset between the two frames of reference for each eye. The origin offset value may be determined as part of a calibration routine performed for a specific user and/or eye tracking system 340.

If the gaze direction module provides the left eye gaze origin data and the right eye gaze origin data with respect to a single frame of reference for both eyes (for example an image of both eyes is recorded by a single image sensor), a horizontal component of the threshold range may be centered around an eye separation offset value corresponding to a separation of the center of the user's eyes (interocular distance). In such examples, a first threshold may correspond to a value greater than the eye separation offset value and a second threshold may correspond to a value less than the eye separation offset value. The eye separation offset value may be determined as part of a calibration routine performed for a particular user. The gaze quality analyzer 344 may compute the interocular distance from the left gaze origin and the right gaze origin. The computed interocular distance may be compared against the threshold range. The interocular distance may also be compared against a population distribution to determine if the value is anatomically possible.

If the gaze origin difference value falls outside the threshold range, the gaze quality analyzer 344 may provide a FALSE gaze quality value. If the gaze origin difference value is within the threshold range, the gaze quality analyzer 344 may provide a TRUE gaze quality value.

The one or more gaze origin thresholds may correspond to different directional components or axes. For example, a first threshold may relate to a horizontal component of the gaze origin difference value and a second threshold may relate to a vertical component of the gaze origin difference value. In some examples, the gaze quality analyzer 344 may compare a magnitude of the gaze origin difference value (minus an optional eye separation offset value depending on the frame of reference) to a single gaze origin threshold.

Use of the gaze origin or gaze direction as the gaze data may provide a more robust gaze quality value depending on how each of the gaze origin or gaze direction is calculated. For example, in some eye tracking systems, the gaze origin may be determined solely from glint detection and matching whereas the gaze direction may depend on both the gaze origin and the pupil position. As a result, the gaze direction is prone to errors in both the gaze origin determination and the pupil position determination. In contrast, the gaze origin determination may only be prone to errors in the glint matching. In other examples, the gaze origin and gaze direction may be determined in a different manner and the gaze origin may be more error prone. Selecting the more error prone gaze data can provide a more robust gaze quality value and an indication that both the gaze origin and gaze direction are error free.

In some examples, the left eye gaze data and the right eye gaze data may correspond to a single image frame for each eye. In other examples, the left eye gaze data and the right eye gaze data may correspond to a sequence or buffer of image frames for each eye, for example two, three, four, five or more image frames (optionally consecutive image frames). In such examples, the gaze quality analyzer 344 may determine a gaze difference value for each image frame and determine the gaze quality value based on whether or not all the gaze difference values fall within the threshold range. In this way, the gaze quality value is more reliable and the probability of obtaining a spurious TRUE value due to the gaze data for the left eye and right eye having the same error is reduced.

In some examples, the gaze quality analyzer 344 may compare the left eye gaze data and the right eye gaze data to one or more gaze feasibility thresholds. The gaze quality analyzer 344 may make such a comparison prior to calculating the gaze difference value. The one or more gaze feasibility thresholds may correspond to gaze origin values or gaze direction values that are anatomically unfeasible or uncomfortable. For example, the gaze feasibility thresholds may delimit a gaze direction lying outside an anatomically possible field of view or a corneal center lying outside the boundaries of the eye. The one or more feasibility thresholds may define a feasibility threshold range. For example, a gaze direction feasibility threshold range may comprise an upward gaze direction feasibility threshold, a downward gaze direction feasibility threshold, an outward gaze direction threshold and an inward gaze direction threshold. The feasibility threshold range may be asymmetric, for example a magnitude of the upward gaze direction feasibility threshold may be less than the magnitude of a downward gaze direction feasibility threshold as it can be anatomically less comfortable for a user to gaze upwards rather than downwards. The gaze quality analyzer 344 may provide a FALSE gaze quality value if the left eye gaze data and/or the right eye gaze data is outside the feasibility threshold range. The feasibility threshold range may be determined during a calibration routine for a particular user in some examples. In other examples the feasibility threshold range, may be hard-coded. For a remote system, the feasibility threshold range may take account of a head tilt or head pose of the user relative to the camera or image sensor. In this way, the feasibility threshold may vary dynamically based on a head tilt of the user.

In some examples, the gaze estimation module 342 may return no value or a null value for the left eye gaze data or the right eye gaze data. This may occur when a user blinks or winks or when an image has spurious features from stray light. In some examples, the eye tracking system 340 may store the left eye gaze data and the right eye gaze data for a particular image frame as key frame data when the gaze quality value is TRUE. The gaze quality analyzer 344 can use the key frame data as reference data for managing null values of gaze data for either eye. For example, if either the left eye gaze data or the right eye gaze data has no value for one or more subsequent (consecutive) image frames and the gaze data for the other eye has definite value, the gaze quality analyzer 344 may determine the gaze quality difference value for each of the one or more frames based on a difference between the gaze data and the key frame data for the other eye. The gaze quality analyzer may provide a TRUE gaze quality value for each of the one or more image frames while the gaze difference value is within the threshold range and until the gaze difference value is outside the threshold range. After this point, the gaze quality analyzer 344 may return a FALSE gaze quality value until both the left and right eye gaze data have definite values and the gaze difference value is within the threshold range. The key frame data may not be updated until both the left and right eye gaze data have definite values and the gaze quality value is TRUE.

In some examples, if the gaze quality value is TRUE the gaze quality analyzer 344 may tolerate receiving no value for both the left eye gaze data and the right eye gaze data and continue to return a TRUE value for a predetermined number of subsequent (consecutive) image frames. In this way, the eye tracking system is more robust to blink events and can resume gaze tracking after the blink event.

In some examples, if the gaze quality value is TRUE, the gaze quality analyzer 344 may tolerate a gaze difference value outside the threshold range and continue to return a TRUE value for a predetermined number of subsequent (consecutive) image frames. The predetermined number of subsequent image frames may be one subsequent image frame. In this way, the eye tracking system may allow for a spurious error in a single image frame or a short sequence of image frames. This can reduce the computational requirements of the eye tracking system as the intermediate values can remain locked in the event of an isolated error in an otherwise error free tracking sequence.

FIG. 4 illustrates a method of providing a quality measure of a calculated gaze of a user in an eye tracking system according to an embodiment of the present disclosure.

Step 450 comprises receiving left eye gaze data associated with a left eye of the user from a gaze estimation module. Step 452 comprises receiving right eye gaze data associated with a right eye of the user from the gaze estimation module. Step 454 the comprises comparing the left eye gaze data and the right eye gaze data to determine a gaze difference value. Step 456 comprises providing a gaze quality value of the gaze data based on the gaze difference value.

What is claimed is:

1. An eye tracking system for providing a quality measure of a calculated gaze of a user, the eye tracking system comprising a controller configured to:
receive gaze data comprising left eye gaze data associated with a left eye of the user and right eye gaze data associated with a right eye of the user;
compare the left eye gaze data and the right eye gaze data to determine a gaze difference value; and
provide a gaze quality value of the gaze data based on the gaze difference value.

2. The eye tracking system of claim 1, wherein the controller is configured to provide the gaze quality value based on whether or not the gaze difference value is within a threshold range.

3. The eye tracking system of claim 2, wherein the controller is configured to provide the gaze quality value as TRUE if the gaze difference value is within the threshold range and to provide the gaze quality value as FALSE if the gaze difference value is outside the threshold range.

4. The eye tracking system of claim 1, wherein the left eye gaze data and the right eye gaze data comprise gaze direction data.

5. The eye tracking system of claim 1, wherein the left eye gaze data and the right eye gaze data comprise gaze point data corresponding to an intersection of a respective left eye gaze ray and right eye gaze ray with a plane or surface.

6. The eye tracking system of claim 1, wherein the left eye gaze data and the right eye gaze data comprise gaze origin data.

7. The eye tracking system of claim 6, wherein:
the left eye gaze data and the right eye gaze data correspond to a same frame of reference;
the controller is further configured to provide the gaze quality value based on whether or not the gaze difference value is within a gaze origin threshold range; and
a horizontal component of the gaze origin threshold range is centered around an eye separation offset value.

8. The eye tracking system of claim 1, wherein the left eye gaze data and the right eye gaze data correspond to a single image frame for each of the left eye and the right eye.

9. The eye tracking system of claim 1, wherein the left eye gaze data and the right eye gaze data correspond to a plurality of image frames for each eye and wherein the controller is further configured to:
determine a gaze difference value for each image frame of the plurality of image frames; and
determine the gaze quality value based on whether or not all of the gaze difference values are within a threshold range.

10. The eye tracking system of claim 1, wherein the controller is further configured to:
compare the left eye gaze data and the right eye gaze data to a feasibility threshold range; and
provide the gaze quality value as FALSE if one or more of the left eye gaze data or the right eye gaze data is outside the feasibility threshold range.

11. The eye tracking system of claim 1, wherein the eye tracking system is configured to output the gaze data to a subsequent application based on the gaze quality value.

12. The eye tracking system of claim 1, further comprising one or more intermediate modules configured to determine an intermediate value for determining the gaze data, wherein the controller is further configured to provide the gaze quality value to the one or more intermediate modules such that the intermediate modules can calculate the intermediate value based on the gaze quality value.

13. The eye tracking system of claim 12, wherein the one or more intermediate modules are configured to:
reset if the gaze quality value is FALSE; and
use the intermediate value as a starting point for determining the intermediate value for a subsequent image frame if the gaze quality value is TRUE.

14. The eye tracking system of claim 10, wherein the one or more intermediate modules comprise any of a pupil detection module, a glint matching module, a corneal center estimation module and a gaze estimation module.

15. The eye tracking system of claim 3, wherein the eye tracking system is configured to store the right eye gaze data and the left eye gaze data as key frame data if the gaze quality value is TRUE.

16. The eye tracking system of claim 15, wherein if (1) the gaze quality value is TRUE and (2) one of the left eye gaze data and the right eye gaze data comprises no value for a subsequent image frame and the other one of the left eye gaze data and right eye gaze data comprises a definite value for the subsequent image frame, then the controller is configured to compare the definite value to the key frame data to determine the gaze difference value.

17. The eye tracking system of claim 3, wherein if (1) the gaze quality value is TRUE and (2) the left eye gaze data and the right eye gaze data comprise no value for up to a predetermined number of subsequent image frames, then the controller is configured to provide the gaze quality value as TRUE.

18. The eye tracking system of claim 3, wherein if (1) the gaze quality value is TRUE and (2) the gaze difference value is outside the threshold range for up to a predetermined number of subsequent image frames, then the controller is configured to provide the gaze quality value as TRUE.

19. The eye tracking system of claim 1, wherein the eye tracking system is a component of a head mounted device.

20. A method of providing a quality measure of a calculated gaze of a user, the method comprising:
receiving gaze data comprising left eye gaze data associated with a left eye of the user and right eye gaze data associated with a right eye of the user;
comparing the left eye gaze data and the right eye gaze data to determine a gaze difference value; and
providing a gaze quality value of the gaze data based on the gaze difference value.

21. A computer-readable storage medium storing computer-executable instructions that, when executed by a processor, causes the processor to:
receive gaze data comprising left eye gaze data associated with a left eye of a user and right eye gaze data associated with a right eye of the user;
compare the left eye gaze data and the right eye gaze data to determine a gaze difference value; and
provide a gaze quality value of the gaze data based on the gaze difference value.
